(19) United States
(12) Patent Application Publication
(10) Pub. No.: US 2002/0065796 A1
(43) Pub. Date: May 30, 2002

(54) Web based automated office procedure system

(76) Inventor: Joshua Cohen, North Brunswick, NJ (US)

Correspondence Address: DICKSTEIN SHAPIRO MORIN & OSHINSKY LLP, 2101 L STREET NW, WASHINGTON, DC, 20037-1526, US

(21) Appl. No.: 09/726,033

(22) Filed: Nov. 30, 2000

(51) Int. Cl. G06F 7/00

(52) U.S. Cl. 707/1

(57) ABSTRACT

1. A method of and system for automating office procedure using a web browser on a computer network. The method includes (a) displaying, adding, modifying, and deleting documents; (b) displaying, adding, modifying, and deleting profiles; (c) displaying and modifying access privileges; (d) displaying, writing, sending, and receiving e-mail; (e) displaying, adding, modifying, and deleting projects; (f) displaying, adding modifying, and deleting accounts; (g) associating projects with accounts; (h) removing project associations; (i) adding, modifying, and removing tasks; (j) adding, modifying, and removing priorities from tasks; (k) displaying tasks by priority and/or project; (l) displaying, adding, modifying, and removing timesheets; and (m) displaying, adding, modifying, and deleting accounts. The system includes an internet based automated office procedure program having a computer memory; a web browser; a database; a document viewer which displays lists of files on the server and the contents of individual files in the web browser; an e-mail editor; a profile editor; a project manager; a task manager; a timesheet manager; and an account manager.

### FIELD OF THE INVENTION

The present invention relates to a user interface for a computer and more particularly to a method and apparatus for automating office procedure using a web browser.

### BACKGROUND OF THE INVENTION

A computer network consists of a server and clients. A server is a computer that data and files are stored on. Clients are computers that can access the Server to retrieve or store data and files. Clients can also run programs that are stored on a Server. A network allows the sharing of resources and files.

A different operating system is required for a network than for a personal computer. A network operating system must allow many computers to retrieve and store data and files. The operating system will be more complex because it will have to resolve conflicts when more than one client requests the same file.

Shortly after the widespread use of computers, sharing computer files became a necessity. Whenever people are collaborating on a project, allowing many people to share files simplifies the process. Networking solved this problem. Networking also allows many people to share resources. But, in order to access the network, a computer must be connected to it which employs the same operating system. A computer can be connected to the network physically or over a phone line. This does not, however simplify the process of restricting access to files or allowing people to obtain a fast connection to the network.

Therefore, there exists a need in the art for a method and apparatus that allows a company to restrict access individually to files and at the same time allow access to the company files from a web browser.

### SUMMARY OF THE INVENTION

The present invention allows a company to use the internet instead of running a network to overcome the above-noted disadvantages. Any computer that has a web browser connected to the internet can connect to the server and function as though it is part of the network. The computer will be able to access any of the company files on the server that the user has access to. The present invention also provides a medium for disseminating company news and information. User access to each file can be individually restricted or access can be restricted to groups of files. Also, users can be granted access to all files associated with a particular project or account. This allows companies to restrict the access to files to those people collaborating on a project.

It is, therefore, an object of the invention to provide easier connectivity to a network and more sophisticated file access restrictions than the prior art.

It is further an object of this invention to provide a computer system publishing program that comprises a computer memory, a web browser, a database, a document viewer that displays lists of files on the server and the contents of individual files in the web browser, an e-mail editor, a profile manager, a task manager, a timesheet manager, and an account manager.

It is further an object of this invention that the database is an SQL server.

It is further an object of this invention that the database contains documents, articles, profiles, projects, accounts, tasks, e-mails, and timesheets.

It is further an object of this invention that the profiles contain login names, passwords, and access privileges.

It is further an object of this invention that the privileges determine which files a particular user has access to and whether that user can edit profiles.

It is further an object of this invention that the document viewer displays and stores files in a format that can be read by a word processing program or spreadsheet program.

It is further an object of this invention that the e-mail editor allows e-mail to be written, sent, and viewed.

It is further an object of this invention that the profile editor allows users to be added, deleted, and modified.

It is further an object of this invention that the profile editor allows access privileges to be modified.

It is further an object of this invention that the project manager allows files to be associated with a project.

It is further an object of this invention that access can be granted to all files associated with a project by designating the project alone.

It is further an object of this invention that the task manager displays, adds, and modifies tasks with project designations.

It is further an object of this invention that tasks can have priorities added, modified, or deleted.

It is further an object of this invention that tasks can be sorted by priority.

It is further an object of this invention that tasks can be sorted by project and priority.

It is further an object of this invention that the timesheet manager allows timesheets to be modified.

It is further an object of this invention that account manager allows accounts to be added, modified, and deleted.

It is further an object of this invention that the account manager allows projects to be associated with accounts, removed from accounts, or modified.

It is further an object of this invention that the system includes an article manager.

It is further an object of this invention that the article manager allows articles to be added, modified, or deleted.

It is further an object of this invention that the article manager allows articles to be designated as high priority.

It is further an object of this invention that high priority articles be displayed when a user logs in to an account.

It is further an object of this invention that the article manager allow articles to be searched and viewed.

It is further an object of this invention to provide a method of automating office procedure using a web browser on a computer network comprising displaying, adding, modifying, and deleting documents; displaying, adding, modifying, and deleting profiles; displaying and modifying access privileges; displaying, writing, sending, and receiving email; displaying, adding, modifying, and deleting projects; displaying, adding modifying, and deleting accounts; associating projects with accounts; removing project associations; adding, modifying, and removing tasks; adding, modifying, and removing priorities from tasks; displaying tasks by priority and/or project; displaying, adding, modifying, and removing timesheets; displaying, adding, modifying, and deleting accounts.

It is further an object of this invention that the computer system further comprises displaying, adding, modifying, and deleting articles.

### BRIEF DESCRIPTION OF THE DRAWINGS

FIG. 1 is an organizational chart for a web based automated office procedure system in accordance with a preferred embodiment of the present invention.

FIG. 2 is an organizational chart of a web based automated office procedure system's document viewer in accordance with a preferred embodiment of the present invention.

FIG. 3 is an organizational chart of a web based automated office procedure system's e-mail editor in accordance with a preferred embodiment of the present invention.

FIG. 4 is an organizational chart of a web based automated office procedure system's profile editor in accordance with a preferred embodiment of the present invention.

FIG. 5 is an organizational chart of a web based automated office procedure system's project manager in accordance with a preferred embodiment of the present invention.

FIG. 6 is an organizational chart of a web based automated office procedure system's article viewer in accordance with a preferred embodiment of the present invention.

FIG. 7 is an organizational chart of a web based automated office procedure system's task manager in accordance with a preferred embodiment of the present invention.

FIG. 8 is an organizational chart of a web based automated office procedure system's timesheet manager in accordance with a preferred embodiment of the present invention.

FIG. 9 is an organizational chart of a web based automated office procedure system's account manager in accordance with a preferred embodiment of the present invention.

### DETAILED DESCRIPTION OF PREFERRED EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that structural changes may be made and equivalent structures substituted for those shown without departing from the spirit and scope of the present invention.

The invention comprises an apparatus and method for automating office procedure using the internet.

In a preferred embodiment of the system, the web site is set up on a server. The server is connected to the Internet or an Intranet. Any user can access the web site from anywhere he or she can connect to the Internet if the user has a password. The server contains the files for the web site and the database. The database archives all of the information for the web site. There are entries for each user's profile, each document, emails, projects, articles, tasks, timesheets, and accounts. The database is set up when the software is installed. It initially has no entries of any kind. Once the software is functioning, the user can modify the database using the options available on the main page 1000. The software operates like any web page. The user can go back at any time using the functions of the web browser or can use the links that appear on every page.

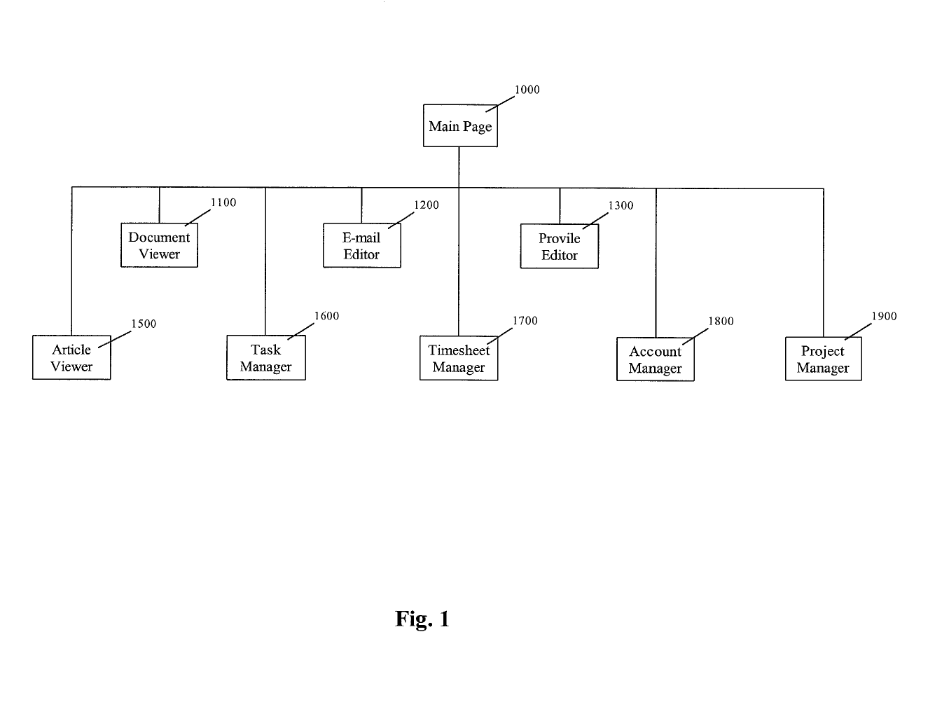

The web page shown in FIG. 1 includes a main page 1000 with links to a document viewer 1100, e-mail editor 1200, profile editor 1300, project manager 1400, article viewer 1500, task manager 1600, a timesheet manager 1700, and an account manager 1800. VVhen a user enters a login and password, the software accesses the database to determine what privileges the user has and displays the options that are available to that user.

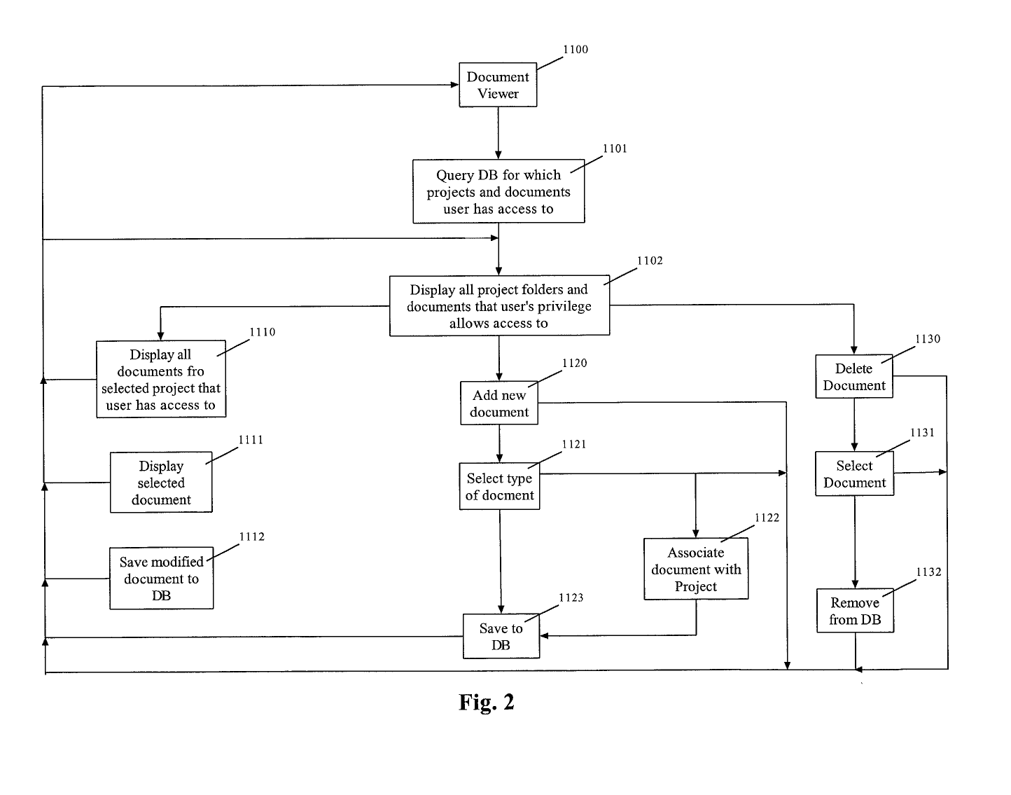

The document viewer 1100, shown in FIG. 2, allows the documents that the user has access to to be viewed. Every user will have access to the document viewer. When a user logs in, the database is queried 1101 to determine which projects and documents that user has access to. A list of documents that are not associated with any project and folders for each project are displayed 1102. The user can then display a document 1111 or select a project to see a list of documents for that project 1110. The document can be modified and saved 1112 or the user can return to document list 1102.

From the document viewer 1100, a new document can also be created 1120. The type of document must be selected 1121 (word processor, spreadsheet, etc.). After the user enters the information in the document, he can either associate it with a project 1122 and then save it to the database 1123 or he can save it to the database 1123 without associating it with a project. Documents can also be deleted from the document viewer 1130. Once the user selects a document 1131, he can either return to the document viewer 1100 without saving or remove it from the database 1132.

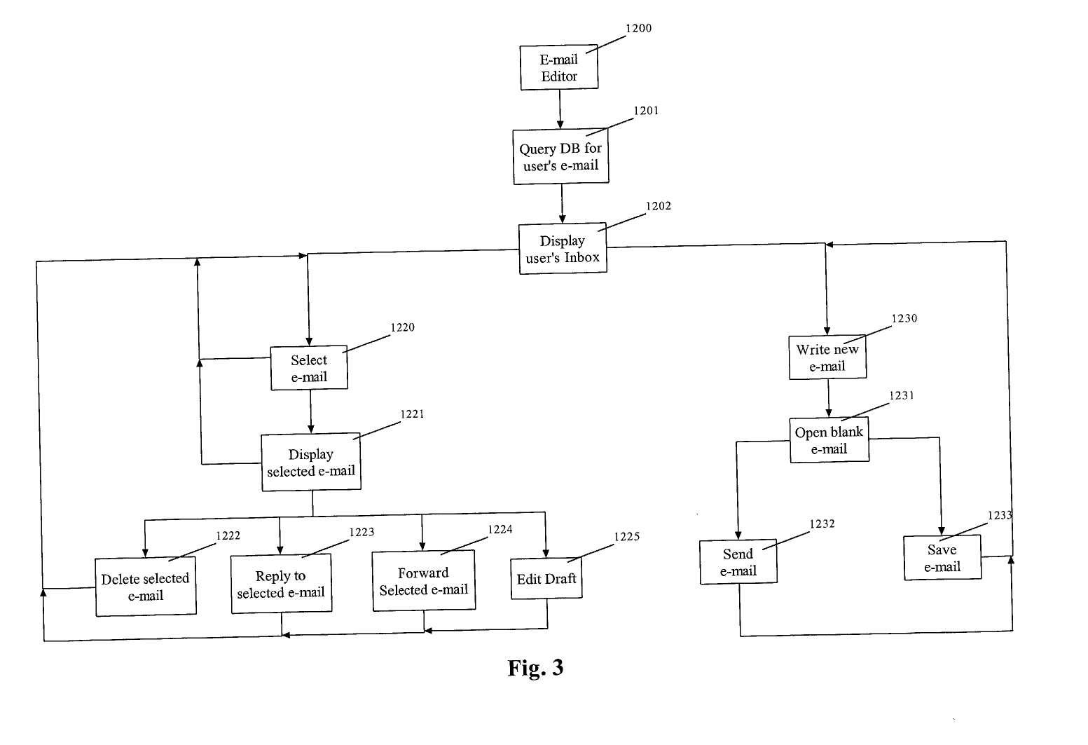

The e-mail editor 1200, shown in FIG. 3, allows the user to access his e-mail account. When the user logs in, the database is queried 1201 for the user's e-mail account. The software will then display the user's inbox 1210. When an e-mail is selected 1220, the software displays it 1221. Then, the user can delete the selected e-mail 1222, reply to the author of the e-mail 1223, forward the e-mail 1224, or edit it 1225 if it was a draft that was saved 1233. When the user elects to write a new e-mail 1230, the software opens a blank e-mail 1231. The user can either send the e-mail 1232, or save it 1233.

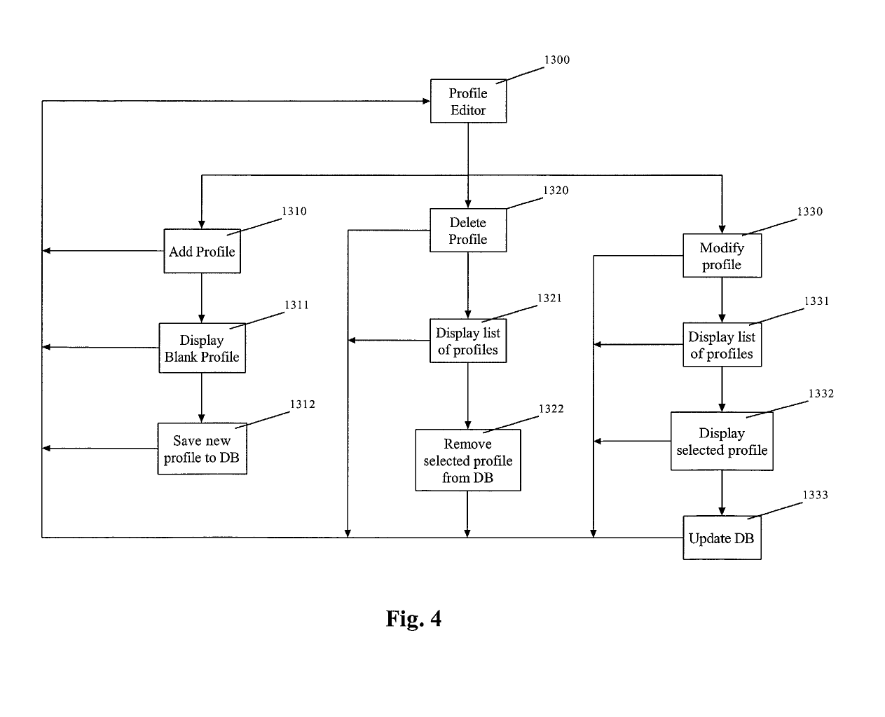

The profile editor 1300, shown in FIG. 4, allows a user to edit user profiles. Only the administrator's of the program will have access to this option. When the user chooses to add a profile 1310 a blank profile is displayed 1311. The user can enter the information and then save the new profile to the database 1312. If the user selects to delete a profile 1320, a list of profiles is displayed 1321. If the user chooses to delete the selected profile, it is removed from the database 1322. Profiles can also be modified 1330. When the user chooses to modify a profile 1330, a list of profiles is displayed 1331. Once the user selects a profile, it is displayed 1332. The user can change any information in the profile and then save the modified profile to the database 1333.

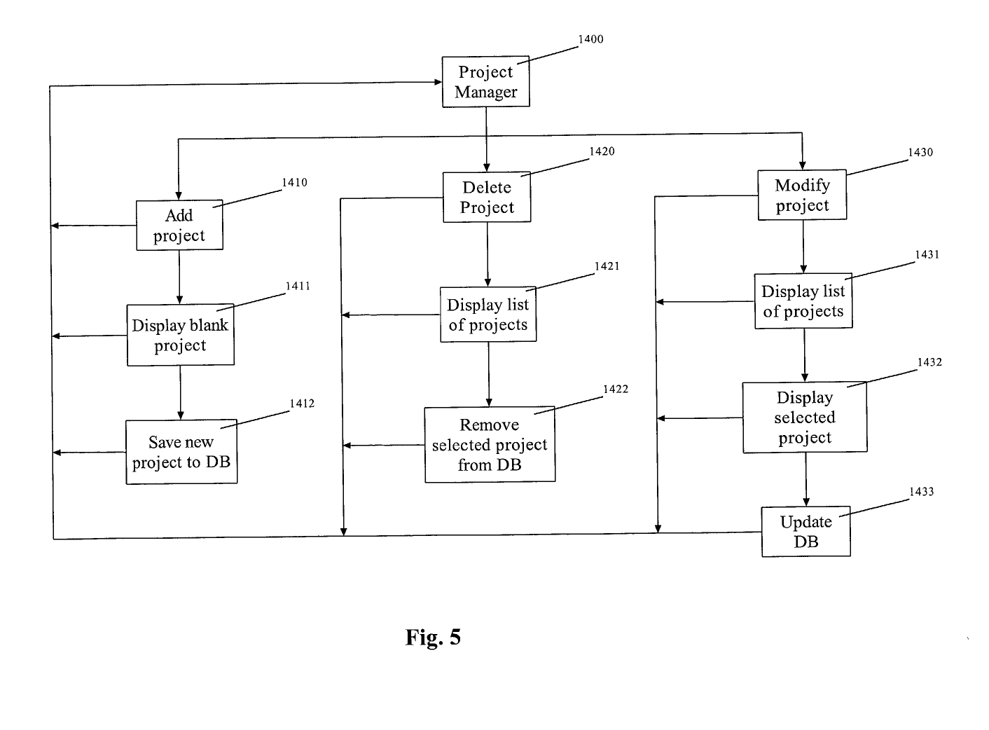

The project manager 1400, shown in FIG. 5, allows a user to edit projects. When the user chooses to add a project 1410, a blank project form is displayed 1411. The user can enter the information and either save the new project to the database 1412 or return to the project manager 1400. When the user chooses to delete a project 1420, a list of projects is displayed 1421. The user has to select a project and can either delete the project from the database 1422 or return to the project manager 1400. A user can also modify pre-existing projects 1430. A list of projects is displayed 1431 for the user to choose from. Once the user selects a project, that project is displayed 1432. Then the user can choose to either update the database 1433 or return to the project manager 1400.

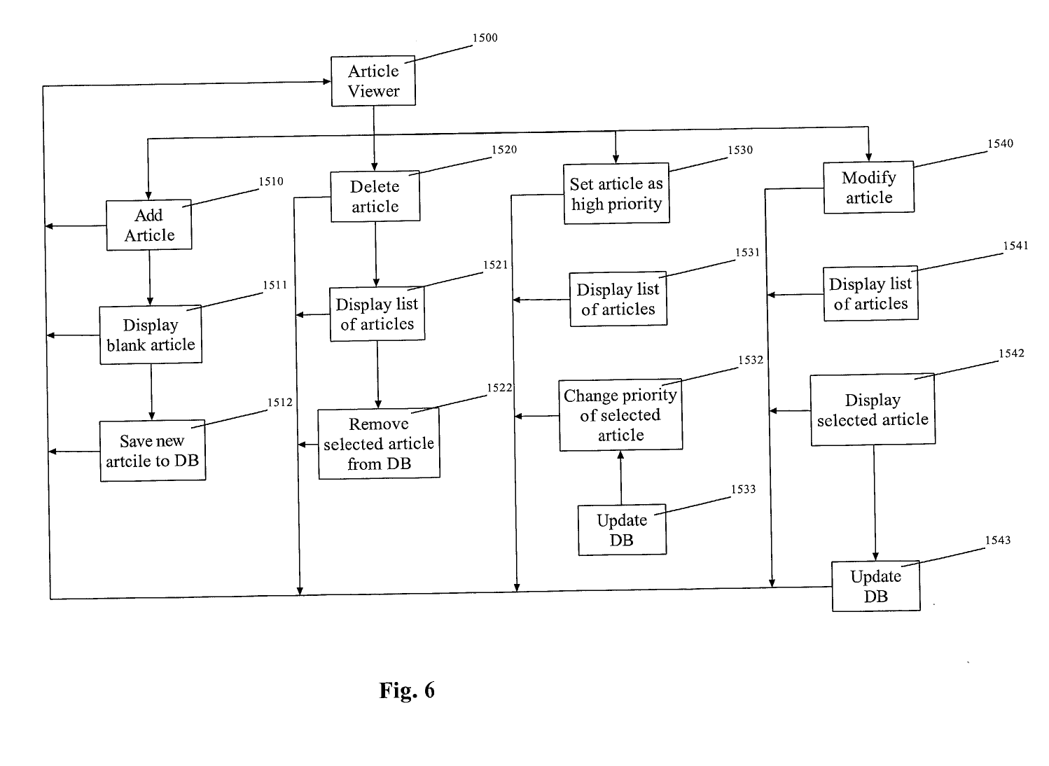

The article viewer 1500, shown in FIG. 6, allows a user to edit articles. When the user chooses to add an article 1510, a blank article form is displayed 1511. The user can enter the information and either save the new article to the database 1512 or return to the article viewer 1500. When the user chooses to delete an article 1520, a list of articles is displayed 1521. The user has to select an article and can either delete the article from the database 1522 or return to the article viewer 1500. A user can also set an article as high priority 1530. This will cause the headline of the article to be displayed on the main page 1000 all employees see when they log in. A list of articles is displayed 1531 for the user to change the priority of a selected article 1532. The user can either save the change to the database 1543 or return to the article viewer. A user can also modify pre-existing articles 1540. A list of articles is displayed 1541 for the user to choose from. Once the user selects an article, that article is displayed 1542. Then the user can choose to either update the database 1543 or return to the article viewer 1500.

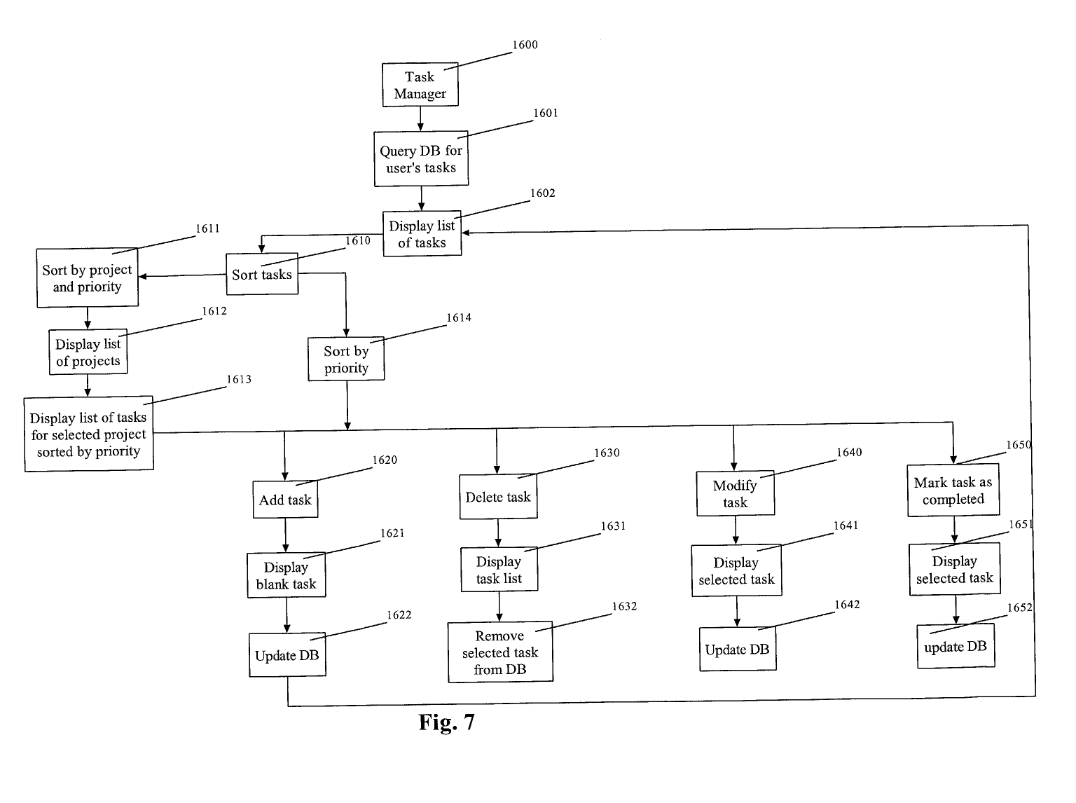

The task manager 1600, shown in FIG. 7, allows a user to view his tasks. When the user selects the task manager 1600, the software queries the database 1601 and displays a list of tasks 1602. The user can choose to display the tasks sorted by priority 1614 or by project and priority 1611. If the user wants his tasks sorted by project and priority 1611, a list of projects is displayed 1612. Once the user selects a project, the tasks for that project are displayed in order of priority 1613.

The task manager 1600 also allows a user to edit his tasks. The user can add a task 1620. A blank task form is displayed 1621 for the user to fill in. Once the form is filled out, the user can either return to the list of tasks 1602 or add the new task to the database 1622. The user can also delete a task 1630. Once a task is selected for deletion, it can be removed from the database 1632 or the user can return to the task list 1602. The user can also modify pre-existing tasks 1640. Once the user selects the task to be modified, the software displays that task 1641. The user can save the changes he makes 1642 or return to the list of tasks 1602. The task manager also allows the user to mark a task as completed 1650. The selected task is displayed 1651 and the user can either save the change to the database 1652 or return to the list of tasks 1602.

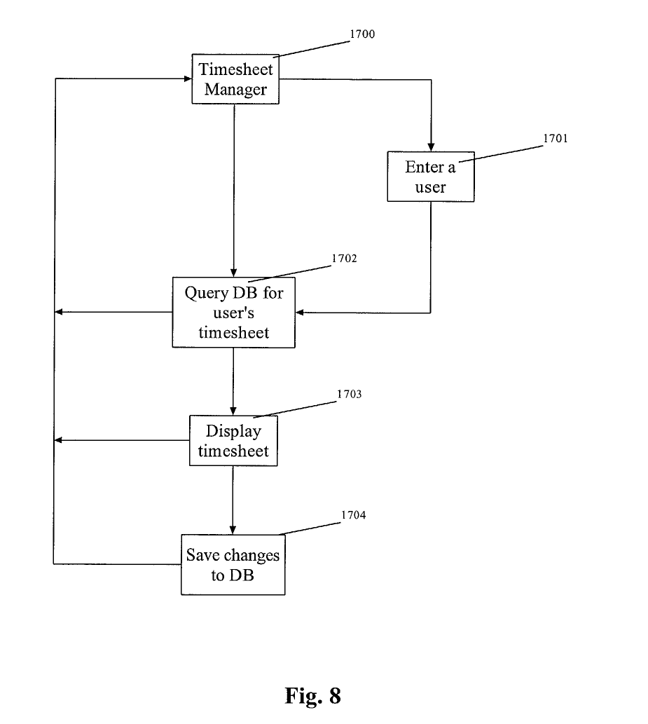

The timesheet manager 1700, shown in FIG. 8, allows timesheets to be viewed and modified. When a user enters the timesheet manager 1700, the database is queried for his timesheet 1702. The timesheet is displayed 1703 for the user to view or modify. If the user decides to modify the timesheet, the changes can be saved to the database 1704. When someone from the accounting department or billing department accesses the timesheet manager 1700, he is prompted to enter a user's name 1701. This allows them to view any person's timesheet 1703.

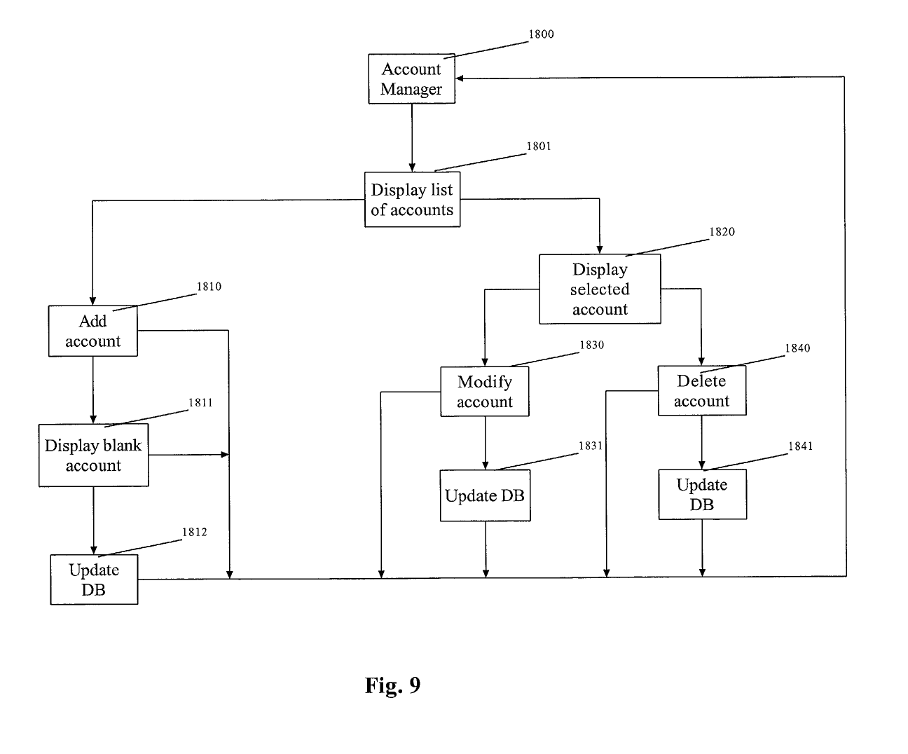

The account manager 1800, shown in FIG. 9, allows a user to edit accounts. When the user enters the account manager 1800, a list of accounts is displayed 1801. If the user chooses to add an account 1810, a blank account form is displayed 1811. The user can enter the information and either save the new account to the database 1812 or return to the account manager 1800. When the user wants to modify an account 1830, the selected account is displayed 1820. The user can alter the information and then either save the modified account to the database 1831 or return to the account manager 1800. When the user wants to delete an account 1840, the selected account is displayed 1820. The user can either remove the account from the database 1841 or return to the account manager 1800.

The invention provides an apparatus and method for allowing a company to automate office procedure using the internet and a computer network. The above description and drawings are only illustrative of preferred embodiments which achieve the objects, features and advantages of the present invention. It is not intended that the present invention be limited to the illustrated embodiments as modifications, substitutions and use of equivalent structures can be made. Accordingly, the invention is not to be considered as limited by the foregoing description, but is only limited by the scope of the appended claims.

What is claimed as new and desired to be protected by Letters Patent of the United States is:

1. A computer system internet based automated office procedure program, said computer system comprising:
a computer memory;
a web browser;
a database;
a document viewer, said viewer displaying lists of files on the server and the contents of individual files in the web browser;
an e-mail editor;
a profile editor;
a project manager;
a task manager;
a timesheet manager; and
an account manager.

2. A computer system as in claim 1, where in said database is an SQL server.

3. A computer system as in claim 1, wherein said database contains documents, articles, profiles, projects, accounts, tasks, e-mails, and timesheets.

4. A computer system as in claim 3, wherein said profiles contain login names, passwords, and access privileges.

5. A computer system as in claim 4, wherein said privileges determine what files a particular user has access to and whether that user can edit profiles.

6. A computer system as in claim 1, where in said document viewer displays and stores files in a format that can be read by a word processing program or spreadsheet program.

7. A computer system as in claim 1, wherein said e-mail editor allows e-mail to be written, sent, and viewed.

8. A computer system as in claim 1, wherein said profile editor allows users to be added, deleted and modified.

9. A computer system as in claim 1, wherein said profile editor allows access privileges to be modified.

10. A computer system as in claim 1, wherein said project manager allows files to be associated with a project.

11. A computer system as in claim 10, wherein access to can be granted to all files associated with a project by designating the project alone.

12. A computer system as in claim 1, wherein said task manager displays, adds, and modifies tasks with project designations.

13. A computer system as in claim 12, wherein tasks can have priorities added, modified, or deleted.

14. A computer system as in claim 13, wherein tasks can be sorted by priority.

15. A computer system as in claim 13, wherein said tasks can be sorted by project and priority.

16. A computer system as in claim 1, wherein said timesheet manager allows timesheets to be modified.

17. A computer system as in claim 1, wherein said account manager allows accounts to be added, modified, and deleted.

18. A computer system as in claim 17, wherein said account manager allows projects to be associated with accounts, removed from accounts, or modified.

19. A computer system as in claim 1, wherein said computer system further comprises an article manager.

20. A computer system as in claim 19, wherein said article manager allows articles to be added, modified, or deleted.

21. A computer system as in claim 20, wherein said article manager allows articles to be designated as high priority.

22. A computer system as in claim 21, wherein said high priority articles are displayed when an account is accessed.

23. A computer system as in claim 20, wherein said article manager allows articles to be searched and viewed.

24. A method of automating office procedure using a web browser on a computer network comprising:
displaying, adding, modifying, and deleting documents;
displaying, adding, modifying and deleting profiles;
displaying and modifying access privileges;
displaying, writing, sending, and receiving e-mail;
displaying, adding, modifying, and deleting projects;
displaying, adding, modifying, and deleting accounts;
associating projects to accounts;
removing project associations;
adding, modifying, and removing tasks;
adding, modifying, and removing priorities from tasks;
displaying tasks by priority and/or project;
displaying, adding, modifying, and removing timesheets;
displaying, adding, modifying, and deleting accounts;

25. A method as in claim 24, wherein said computer system further comprises displaying, adding, modifying, and deleting articles.
